(19) United States
(12) Patent Application Publication
(10) Pub. No.: US 2025/0346063 A1
(43) Pub. Date: Nov. 13, 2025

(54) PAINT TRAY

(71) Applicant: David Kropacek, Hamilton (CA)

(72) Inventor: David Kropacek, Hamilton (CA)

(21) Appl. No.: 18/656,744

(22) Filed: May 7, 2024

(51) Int. Cl. B44D 3/12

(52) U.S. Cl. CPC B44D 3/126; B44D 3/123; B44D 3/125

(57) ABSTRACT

A paint tray that is configured to have a first mode and a second mode wherein in the first mode that paint tray is operable to receive, store and transport painting implements such as but not limited to hand brushes and roller brushes. The invention includes a tray member having first end and a second end. The tray member includes a bottom having a portion thereof operable to receive paint therein. Integrally formed with the tray member is storage compartment. The storage compartment includes a first compartment and a second compartment. The first compartment and second compartment are vertically oriented. The bottom of the first compartment is movable to provide access to the interior volume of the second compartment. The tray member includes a lid member operably secured to provide coverage thereof. An articulating arm member having a base portion is secured to the rear wall of the tray member.

### FIELD OF THE INVENTION

The present invention relates generally to painting equipment, more specifically but not by way of limitation, the present invention provides a paint tray wherein the tray includes an integrated storage area having a first compartment and a second compartment. Furthermore, the present invention includes a hingeable lid over the tray and an articulating support arm.

### BACKGROUND

Painting is one of the most commonly performed tasks in construction and remodel of all types of structures. Applying coats of paint to interior and exterior surfaces is not only performed during initial construction but also performed on a routine basis. Applying coats of paint is performed with various tools such as but not limited to spray equipment, hand brushes and roller brushes. For the latter, roller brushes, as is known in the art are cylindrical brushes mounted to a rolling support device and are operable to be rolled across a surface depositing paint thereon. When utilizing a roller brush it is most common to employ the use of a paint tray wherein the paint tray is configured to receive a volume of paint therein. During use, an individual will load the roller brush with paint by manipulating the roller brush into the paint in the paint tray and roll therein to allow the roller brush to absorb some of the paint.

Many individuals engaged in the act of painting will utilize not only roller brushes but further utilize hand brushes as well. It is quite common for a user to utilize paint stored in a tray to load both a roller brush as well as a hand brush. Conventional paint trays lack the ability to store and receive hand brushes. Additionally, no existing conventional paint tray provides a storage area to store an additional roller brush. During painting, it can be quite common for a user to need another roller brush due to changing color of a paint or other reasons. Conventional paint trays do not provide elements that facilitate an ability to carry a roller brush and handle within the interior volume thereof.

Accordingly, there is a need for a paint tray that can be used to receive and dispense paint wherein the paint tray of the present invention includes a storage area having two defined compartments and further includes elements to facilitate carrying of painting equipment within the interior volume of the tray member when not in use for painting.

### SUMMARY OF THE INVENTION

It is the object of the present invention to provide a paint tray that is configured to be utilized in a first mode and a second mode wherein in the first mode the paint tray is operable to provide storage ofvarious painting implements.

Another object of the present invention is to provide a paint tray that is employed to receive and dispense paint wherein in the second mode of the present invention the paint tray is utilized to receive and dispense paint.

A further object of the present invention is to provide a paint tray that is configured to be utilized in a first mode and a second mode wherein the present invention includes a main compartment configured to releasably secure a liner therein and wherein the main compartment has a lid member operably coupled thereto.

Yet a further object of the present invention is to provide a paint tray that is employed to receive and dispense paint wherein the present invention includes a storage area integrally formed with the main compartment.

Still another object of the present invention is to provide a paint tray that is configured to be utilized in a first mode and a second mode wherein the storage area includes a first compartment and a second compartment.

An additional object of the present invention is to provide a paint tray that is employed to receive and dispense paint wherein the present invention further includes an articulating support arm operably coupled to the main compartment.

Yet a further object of the present invention is to provide a paint tray that is configured to be utilized in a first mode and a second mode wherein the first compartment and second compartment are oriented in a vertically stacked orientation.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention in its stored position; and

FIG. 2 is a top perspective view of the present invention with the lid member of the main compartment in an open position; and

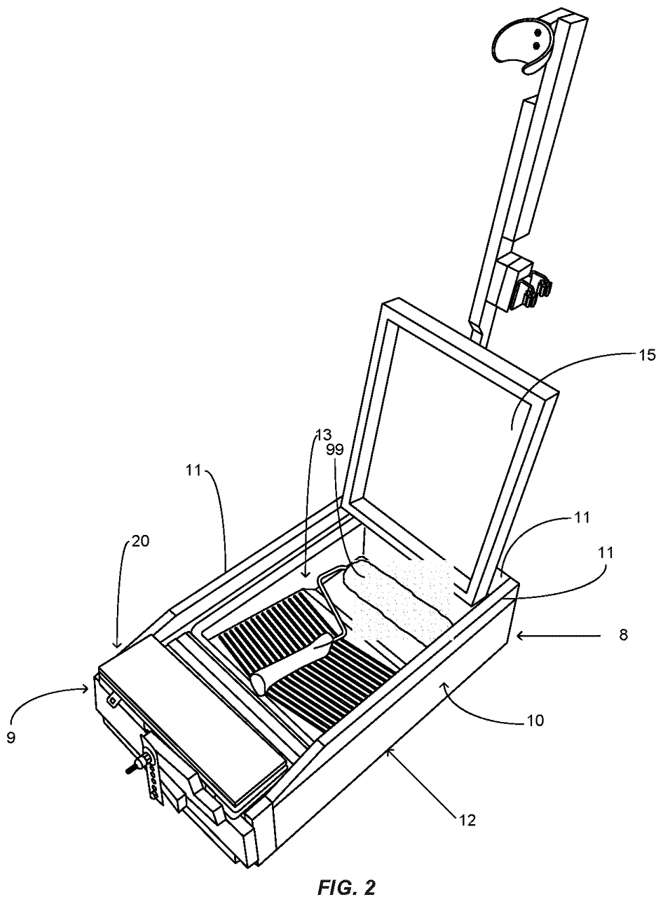

FIG. 3 is a top perspective view of the present invention having the second compartment open; and

FIG. 4 is a top perspective view of the present invention having the first compartment open.

### DETAILED DESCRIPTION

Referring now to the drawings submitted herewith, wherein various elements depicted therein are not necessarily drawn to scale and wherein through the views and figures like elements are referenced with identical reference numerals, there is illustrated a paint tray 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood thatthe terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the paint tray 100 is configured to be operable in a first mode and a second mode. In the first mode the paint tray 100 is operable to assist in the storage and transport of painting implements such as but not limited to roller brushes and hand brushes. In the second mode, the paint tray 100 is operable to receive and store paint in a manner to be accessible for use by a user of the paint tray 100 to paint a desired surface.

The painttray 100 includes a tray member 10. The tray member 10 in a preferred embodiment is rectangular in shape having walls 11 and bottom 12 integrally formed to create an interior volume 13. The tray member 10 has a first end 8 and a second end 9. The bottom 12 is tapered in form wherein the bottom 12 is angled downwards from the second end 9 to the first end 8 wherein the area of the bottom 12 proximate the first end 8 has a depth that is greater than the area of the bottom 12 proximate the second end 9. It should be understood within the scope of the present invention that the interior volume 13 is sized so as to receive therein a conventional liner.

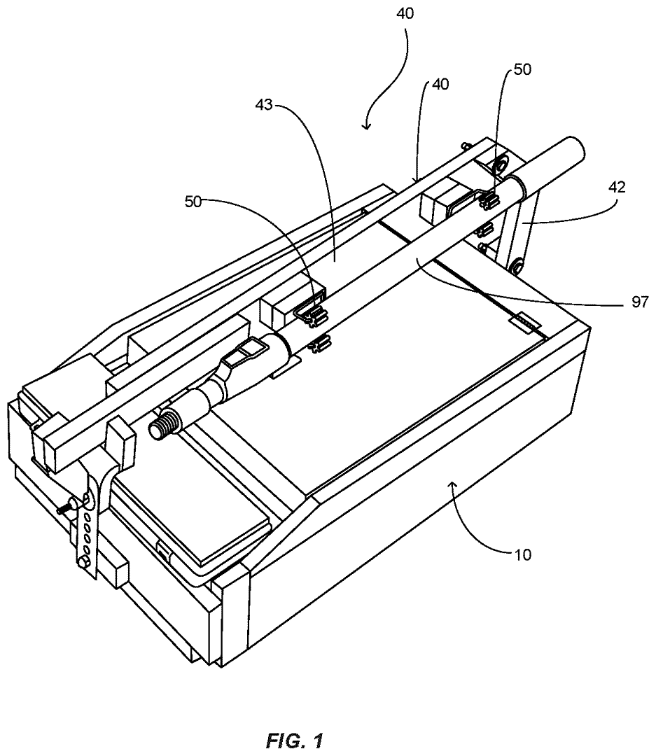

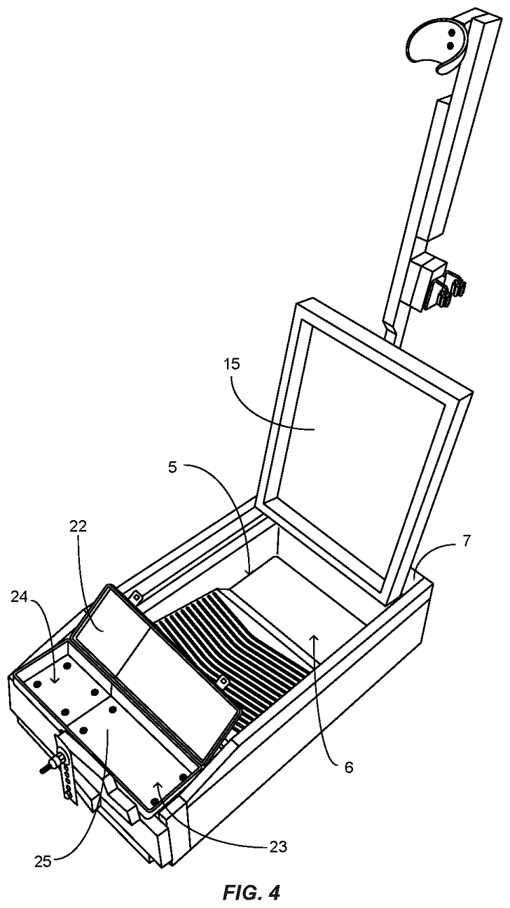

The tray member 10 has a lid member 15 hingedly secured thereto proximate the first end 8. Lid member 15 is hingedly secured to the rear wall 7 employing suitable mechanical elements. The lid member 15 is movable between a first position and a second position. In the first position, illustrated herein in FIG. 1, the lid member 15 covers the opening 6 of the paint receiving area 5. In this position the paint tray 100 can be transported and further provide retention of exemplary roller brush 99 during transport. In the second position, illustrated herein in FIG. 4, the lid member 15 is hinged away from the paint receiving area 5 so as to provide access thereto.

Integrally formed with the tray member 10 is storage compartment 20.

Storage compartment 20 extends the width of the tray member 10 and includes cover member 22 that is operable to provide coverage of the first compartment 24. The first compartment 24 is configured to receive and retain implements such as but not limited to hand brushes. The cover member 22 is movable between an open and a closed position wherein in the open position access to the interior volume 23 of the first compartment 24 is provided. The cover member 22 is hingedly secured so as to facilitate movement between the open and closed position. The bottom 25 of the first compartment 24 is hingedly secured so as to move between a first position and a second position. Directly underneath the first compartment 24 is second compartment 30. Second compartment 30 has an interior volume 31 configured to receive and retain at least one roller brush 98.

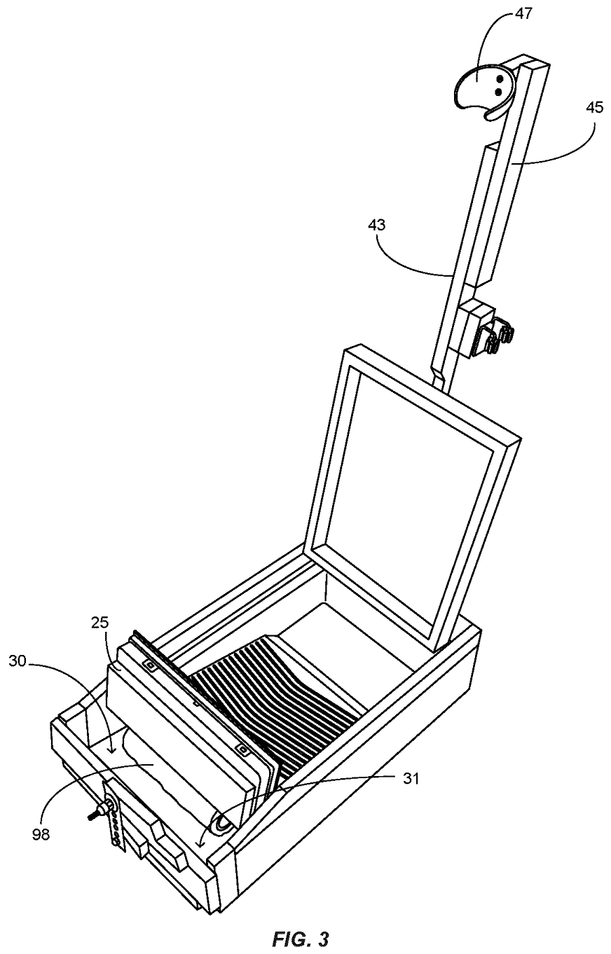

The second compartment 30 is accessible ensuing the bottom 25 being moved to an open position as is illustrated herein in FIG. 3. The second compartment 30 is directly underneath the first compartment 24 being axially aligned therewith in a vertical orientation.

The paint tray 100 further includes an articulating arm member 40. The articulating arm member 40 includes a base portion 42 that is operably coupled to the rear wall 7 of the tray member 10. The base portion 42 has segment 43 pivotally secured thereto wherein segment 43 is movable between a collapsed position (illustrated in FIG. 1) and a deployed position (illustrated herein in FIG. 3). The segment 43 includes handle support member 45 secured thereto wherein handle support member 45 has handle receiving member 47 secured to the end thereof. In its deployed position, the segment 43 is placed in a vertical orientation wherein the receiving member 47 is in a position to retain and receive a handle member 97 coupled to roller brush 99. Segment 43 includes clip members 50 secured thereto utilizing suitable durable techniques. The clip members 50 are configured to receive and store handle member 97 when not in use and coupled to roller brush 99. It is contemplated within the scope of the present invention that the clip members 50 could be provided in alternate quantities and embodiments to achieve the desired objective discussed herein. It is further contemplated within the scope of the present invention that the articulating arm member 40 could be provided in alternate lengths and further have more than one segment 43.

In the preceding detailed description, reference has been made to the accompanying drawings that form a part hereof, and in which are shown by way of illustration specific embodiments in which the invention may be practiced.

These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A paint tray configured to be operable in a first mode and a second mode wherein the paint tray comprises:
a tray member, said tray member having a plurality of walls and a bottom integrally formed to create an interior volume, said tray member having a first end and a second end;
a lid member, said lid member being planar in manner, said lid member being hingedly coupled to said tray member proximate said second end thereof, said lid movable between a first position and a second position, said lid member having a size suitable to cover an opening of said tray member;
a storage compartment, said storage compartment being integrally formed with said tray member proximate said first end of said tray member, said storage compartment having a cover member, said cover member hingedly coupled to said storage compartment across a first opening thereof, said cover member movable between an open position and a closed position, said cover member providing access to a first compartment in said open position, said first compartment having an interior volume, said first compartment having a bottom, said bottom being movably coupled to said storage compartment, said bottom being movable between a first position and a second position, said bottom operable to cover an opening to a second compartment in said first position, said second compartment having an interior volume accessible ensuing said bottom being moved to said second position; and
wherein in said first mode the paint tray is configured to store painting implements and be transported to a desired location.

2. The paint tray configured to be operable in a first mode and a second mode as recited in claim 1, wherein said first compartment and said second compartment of said storage compartment are vertically oriented.

3. The paint tray configured to be operable in a first mode and a second mode as recited in claim 2, wherein said second compartment is underneath said first compartment.

4. The paint tray configured to be operable in a first mode and a second mode as recited in claim 3, and further including an articulating arm member, said articulating arm member having a base portion secured to said second end of said tray member.

5. The paint tray configured to be operable in a first mode and a second mode as recited in claim 4, wherein said articulating arm member further includes a segment, said segment being pivotally coupled to said base portion.

6. The paint tray configured to be operable in a first mode and a second mode as recited in claim 5, wherein said segment further includes a handle receiving member, said handle receiving member secured to said segment distal to said base portion.

7. The paint tray configured to be operable in a first mode and a second mode as recited in claim 6, wherein said segment further includes a first clip member and a second clip member, said first clip member and said second clip member being configured to receive and retain a roller brush extension handle.

8. The paint tray configured to be operable in a first mode and a second mode as recited in claim 7, wherein in the second mode the paint tray is configured to receive and store paint therein.
